(19) United States
(12) Patent Application Publication
(10) Pub. No.: US 2018/0320988 A1
(43) Pub. Date: Nov. 8, 2018

(54) COMPACT MEMBRANE-BASED HEAT AND MASS EXCHANGER

(71) Applicant: Dais Analytic Corporation, Odessa, FL (US)

(72) Inventors: Brian Johnson, Land O'Lakes, FL (US); Rasool Nasr Isfahani, Tampa, FL (US); Steve Guzorek, Lutz, FL (US)

(21) Appl. No.: 15/969,449

(22) Filed: May 2, 2018

Related U.S. Application Data
(60) Provisional application No. 62/500,174, filed on May 2, 2017.

(51) Int. Cl. F28D 21/00; F28F 3/08; B01D 61/36

(52) U.S. Cl. CPC F28D 21/0015; F28F 2230/00; B01D 61/362; F28F 3/086

(57) ABSTRACT

A membrane-based heat and mass exchanger includes a plurality of slats where each slat has at least one membrane support structure, a plurality of grooves, at least one first inlet port and one first outlet port for a first fluid, and at least one second inlet port and at least one second outlet port for a second fluid. O-rings or gaskets shaped to match the plurality of grooves are inserted and a plurality of selective membranes is secured to the slats over the supports. The assembly is secured using bolts or clamps for compressing the slats and the selective membranes into an assembly of slats. The slats can be plastic and can be formed from multiple plastic sheets that are welded together to form structures for supporting and channeling fluids through the sheet. The sheets can display a serpentine surface for mixing of fluids under flow.

### CROSS-REFERENCE TO A RELATED APPLICATION

This application claims the benefit of U.S. Provisional Application Ser. No. 62/500,174, filed May 2, 2017, the disclosure of which is hereby incorporated by reference in its entirety, including all figures, tables and drawings.

### BACKGROUND OF THE INVENTION

Evaporative cooling is commonly used in cooling towers to create a large interfacial area between the liquid and gaseous phases that enable direct evaporation of liquids. Such cooling towers are limited by their direct contact geometry. Spray nozzles, fill materials, or both are typically used to create a high surface area. The liquid film thickness is not tightly controlled in these devices and it is inevitable that some regions of the liquid are completely evaporated. This leaves nonvolatile components of the liquid to precipitate onto the surface with accumulation of scale deposits. Scaling concerns limit the concentration of dissolved solids allowable in the cooling liquid, which limits the liquids that can be considered for use to generally potable water or heavily treated municipal wastewater. To maintain control of the liquid concentration, concentrated liquid is periodically released to remove solids and make room for the new solids carried in by the makeup water. This increases the water consumption of the tower constitutes a significant concern, with 41% of fresh water withdrawals in the US are for evaporative cooling uses. (U.S. Department of Energy “The Water-Energy Nexus: Challenges and Opportunities” June 2014; and Williams E. D. and Simmons J. E. “Water in the energy industry” BP, 2013)

Selective pervaporation membranes have shown the ability to operate at very high concentration of dissolved solids without fouling, which makes it possible to start with saltwater or many types of untreated wastewater instead of the relatively clean water used in conventional cooling towers. This significantly reduces the pressure imposed on sources of clean water when consumers make the transition to wastewater. In addition, the use of highly concentrated brine in the cooling tower greatly reduces the amount of blow-down discharge needed to maintain a mass balance. Additionally, wastes that cannot be easily treated often are placed in large, permanent, evaporation ponds or lagoons. When there is no practical use for the concentrated brine that builds up by treating this water, the problem becomes prohibitively expensive to remove that concentrated brine from the site.

An additional problem that occurs with conventional cooling towers is that water droplets passing into the air stream can carry deadly legionella bacteria, requiring a great deal of ongoing maintenance effort to keep the device operating safely. Hence there is a greater need for alternate designs of heat and mass exchangers.

Membrane devices have been used to address such problems. In these devices a selective membrane is used to govern the transport of water, or other solvent, from one fluid stream to another. Using prior art techniques, an assembly of membrane supporting structures is molded as a single part. The molds require extremely complex side-action features and many of the features would be limited in complexity to ensure moldability. Additionally, a significant portion of the cost in making such heat and mass exchangers is in the parts used as spacers to create flow channels on both side of the membrane. These spacers are typically, but not exclusively, plastic sheets that are thermoformed into a three-dimensional (3D) shape such as a corrugation.

Hence there is a need to form a selective membrane with a 3D geometry of flow channels without requiring additional spacer parts, and to form the support structures as single components that can be readily combined and secured together yet allow complex 3D geometries to increase efficiencies.

### BRIEF SUMMARY OF THE INVENTION

Embodiments of the invention are directed to a membrane-based heat and mass exchanger, constructed from a plurality of slats, each slat including at least one membrane support structure, a plurality of grooves, at least one first inlet port and one first outlet port for a first fluid, at least one second inlet port and at least one second outlet port for a second fluid. A plurality of O-rings or gaskets is matched to the plurality of grooves and a plurality of selective membranes is supported on the slats. The slats are combined and compressed using a plurality of bolts or clamps into an assembly of slats. The slats can be flat. The slat can have one membrane support structure. The slats can be formed from a plastic. The membrane can be Aqualyte™ or any other membrane that displays selective transport of a single fluid employed with the membrane-based heat and mass exchanger. The slat can have a multiplicity of the at least one membrane support structure wherein the multiplicity of the at least one membrane support structure is partitioned by the grooves into a plurality of combined membrane support structures.

In an embodiment of the invention, the membrane-based heat and mass exchanger employs slats where each slat comprises a multiplicity of sheets. The slat can comprise a multiplicity of sheets comprise a plurality of selective membrane sheets and a multiplicity of plastic sheets. In an embodiment of the invention the sheets comprise structures for forming serpentine channels by the pairing of two of the sheets with identical complementary features of height and pitch, wherein the features in an orientation define a plane defined by contacting the complementary features.

The membrane-based heat and mass exchanger can be configured to function as at least a portion of a chiller, evaporator, dehumidifier, or humidifier.

An embodiment of the invention is directed to a method of preparing a membrane-based heat and mass exchanger. In this method a plurality of slats is provided, each slat comprising at least one membrane support structure, a plurality of grooves, at least one first inlet port and one first outlet port for a first fluid, at least one second inlet port and at least one second outlet port for a second fluid is combined with a plurality of selective membranes. The slats are combined with O-rings or gaskets and secured as an assembly upon compression and fixing by a plurality of bolts or clamps. The slats are aligned such that front faces of adjacent slats are contacted back face of adjacent slats are contacted. The slats can be an assembly of multiple plastic sheets wherein the plastic sheets are patterned in complementary fashion to support the selective membranes to promote non-laminar fluid flow and to secure the selective membranes and other sheets of the assembly. The assembly can be welded into a single slat comprising the selective membrane by placing the sheets between heated plates. The sheets can have structures or features for forming serpentine channels by the pairing of sheets with identical complementary features of height and pitch that when combine define a plane defined by contacting the complementary features of different height and pitch.

Embodiments of the invention are directed to a system and a method for cooling and carbon sequestration, where at least one membrane-based heat and mass exchanger allows reception of a brine solution from an aquifer using a brine extraction well. The removal of the brine solution reduces the pressure of the aquifer permitting the injection of CO₂ into the reduced pressure aquifer using a CO₂ injection well. The brine solution flows as a first fluid into the first inlet ports of the membrane-based heat and mass exchanger where it transports water from the first fluid through the selective membranes of the membrane-based heat and mass exchanger into a second fluid on a side of the selective membrane that is distal to the first fluid. This concentrates the brine solution. The second fluid is removed with the water through the second outlet of the membrane-based heat and mass exchanger with cooling.

### BRIEF DESCRIPTION OF THE DRAWINGS

FIG. 1 shows a stackable fluid handling slat, according to an embodiment of the invention.

FIG. 2 shows an assembly of the slats illustrated in FIG. 1, according to an embodiment of the invention.

FIG. 3 shows a membrane-based slat design with separately sealed membrane sections and a central compression bolt location, according to an embodiment of the invention.

FIG. 4 shows an assembly of the slats illustrated in FIG. 3, according to an embodiment of the invention.

FIG. 5A shows a slat assembled from formed plastic sheets and selective membrane sheets, according to an embodiment of the invention.

FIG. 5B shows a magnified view of the assembled sheets and the flow regions and patterns in the assembly, according to an embodiment of the invention.

FIG. 6 shows a membrane evaporator/condenser component comprising an assembly of formed plastic sheets, according to an embodiment of the invention.

FIG. 7 shows a press for forming assemblies of plastic sheets, according to an embodiment of the invention, where the sheets are welded to seal regions of the assembly.

FIG. 8A shows a 3D selective membrane assembly of a heat and mass exchanger for air-to-air exchange, according to an embodiment of the invention.

FIG. 8B shows a 3D selective membrane assembly of a heat and mass exchanger for a membrane evaporator, according to an embodiment of the invention.

FIG. 9 shows an illustration of the temperature and concentration boundary layers that are forming near a flat surface that inhibit heat and mass transfer across a membrane.

FIG. 10 shows an assembly of substantially identical plastic parts of a heat and mass exchanger that imposes fluid mixing as it flows between surfaces of the parts, according to an embodiment of the invention.

### DETAILED DESCRIPTION OF THE INVENTION

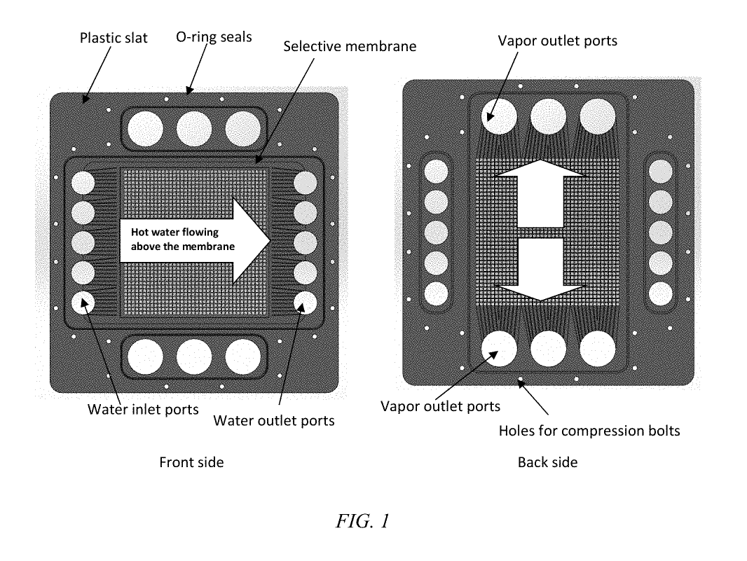

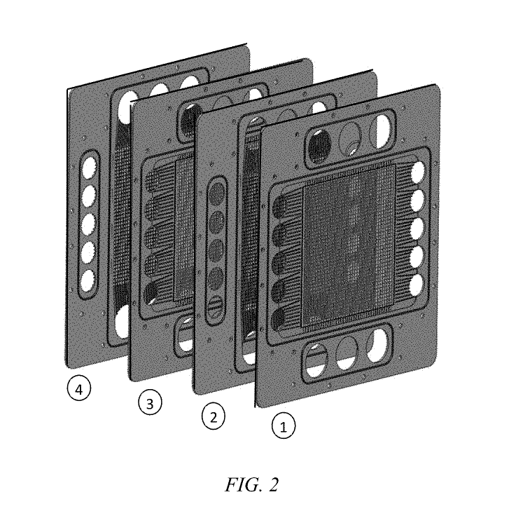

In Embodiments of the invention are directed to a heat and mass exchanger comprising components, also referred to herein as “slats,” as shown in FIG. 1 and FIG. 2 that maintain thin layers of multiple working fluids to exchange heat and mass. The slats can be flat or they can be curved or otherwise shaped in a manner that adjacent slats can be contacted along the entire slats with alignment of the features of the slats. O-rings in grooves seal the individual stream within the slats from each other and from the outside. The slats are stacked in specific orientation to form a heat and mass exchanger. Depending on the arrangement of working fluids and the plenum ports, the slat can be used for chilling, evaporating, dehumidifying or humidifying applications.

As shown in FIG. 1, the slats are arranged to perform as a membrane-based evaporator. Various fluids are passed through the evaporator, including, but not limited to water, waste water, brackish water, seawater and mixtures of such fluids. Hot water is illustrated as the fluid in FIG. 1, with a selective membrane bonded to the middle of the slat. The selective membrane allows a transport of water, or other molecule, selectively through the membrane. A selective membrane that can be used is Aqualyte™, which is a copolymer that partitions portions for water transport to supporting hydrophobic regions. A series of ribs in horizontal and vertical direction or other structures reside under the membrane to provide support for the membrane. As illustrated in FIG. 1, hot water enters from a plurality of inlet ports located on an inlet side of the slat and flows above the membrane. A portion of the water evaporates through the membrane due to a vapor pressure difference across the membrane. The hot water exits through the outlet ports located on the opposite side of the membrane surface to the inlet ports, where the water exits at a lower temperature relative to the inlet due to evaporation of the water. An O-ring groove around the water flow area seals this area.

Larger ports are located at the sides of the slats perpendicular to the inlet and outlet ports on the slat allow the evaporation and flow of water vapor. These ports are sealed on a single “front” side of the slat using O-rings or gaskets. On the opposite “back” side of the slats, the hot water inlet/outlet ports and the vapor flow ports are sealed with O-rings from each other and the outside. Several holes are located around the slats to allow compression bolts to provide the O-rings compression force. Alternatively, other forms of aligning and compressing the slates can be used, such as insertion into a grid of slots or employing one or more clamps external to the slats.

In this arrangement for the liquid and vapor streams, the slats are stacked and assembled in the order and orientation shown in FIG. 2. Each slat is rotatable by 180 degrees around the Y-axis aligned with the vapor inlet and exit ports, as two similar front or back sides with equivalent O-ring grooves face each other for orientation within the stack. The O-rings are placed between adjacent matching O-ring grooves of the adjacent slats. The depth of the O-ring groves is shallower than typical O-ring grooves to encourage O-ring compression as the slats are compressed against each other.

In this embodiment of the invention, a complete heat and mass exchanger is formed that contains internal passages constructed from substantially identical slats. The slates can be formed from thermoplastics (plastics), thermosets, ceramics, metals, or composites of any combination thereof or composites of any of the above with carbon of any composition. In an embodiment of the invention a plastic is employed for the cost and processing advantages thereof. The plastic can be any plastic that can be used at the operating temperature of the heat and mass exchanger, is compatible with the water or other fluid employed, and is not readily eroded under the flow of the fluids. Plastics can be any common plastic, including, but not limited to polyolefins, polyamides, polyesters, polyamides, polyimides, polyaramides, or any other polymeric material that permits a thermal processing.

Using prior art techniques, slats numbered 1 and 2 in FIG. 2 have been molded as a single part. The molds for the combined components require extremely complex side-action features that would limit the shape and structure of the features to allow the molding of the part. By employing the individual stackable slates, according to embodiments of the invention, complex internal features on the slat are possible without complex mold that require many side actions. Because the slats have different planes of symmetry, rotations of the slats allow construction of a multi-slat assembly from a single fabricated slat with the formation of seals by compression on the slates and intermediate O-ring between multiple slates without a requirement to create complicated internal geometries. In one embodiment of the invention, two rotated alignments require the sealing element, the O-ring, to be selectively present on some layers and absent on others, which requires symmetric O-ring grooves that traps the O-rings between identical halves rather than a deep groove on one piece that holds the O-ring and only allows some of the profile to protrude and be compressed. In another embodiment, there may be four rotated alignments, where the sealing element is in the same place on all slats and the slat is rotated to present a seal to a flat receiving surface. This allows use of a standard O-ring groove rather than a shallow groove.

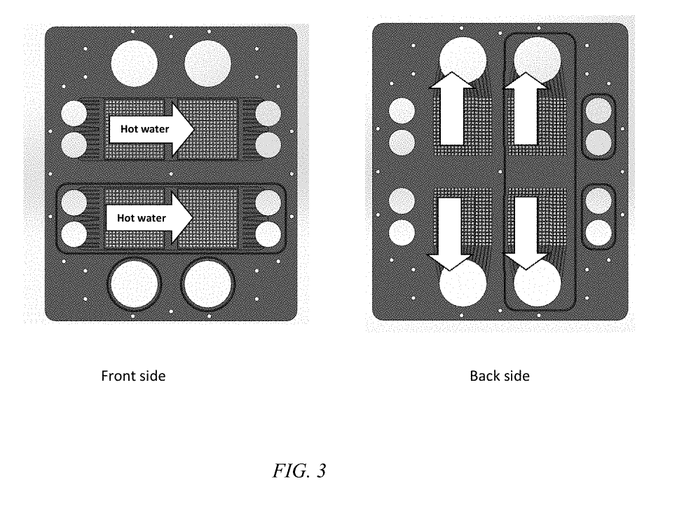

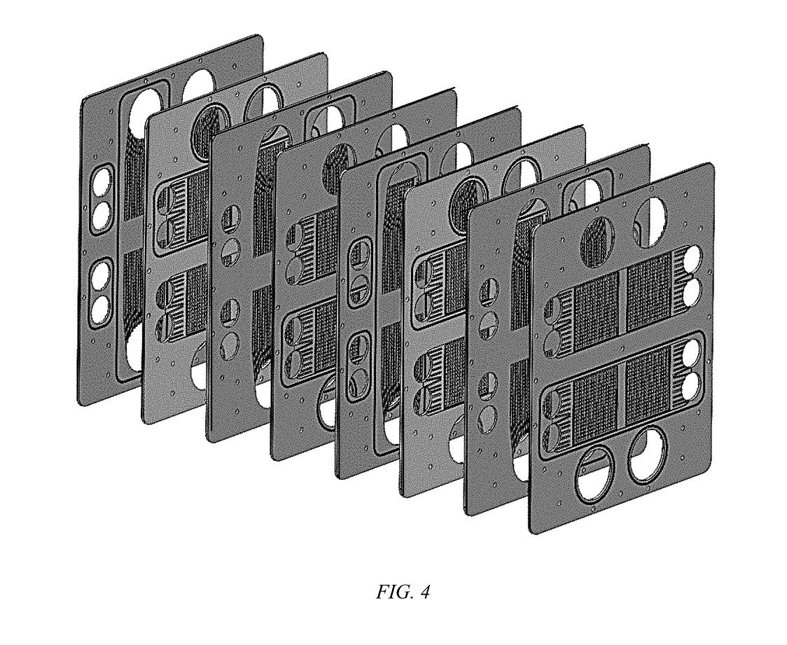

In an embodiment of the invention, the membrane area for mass transfer is divided into four separate sections, as illustrated in FIG. 3. Hot water and vapor flow streams are directed by placing O-rings grooves on one side of the slats that isolates a pair of the sections from the other pair of sections on the face of the slats. When constructed with O-ring seals between a grooved and ungrooved portion of the matched front or back sides the consecutive slats are sealed with isolated pairs of sections, as shown in FIG. 4. This separation of the membrane area into four sections permits the inclusion of at least one compression bolts situated in the central area of the slats, with one specifically illustrated in FIG. 3 at the center of the slat. Plastic slats are typically too flexible to fully transfer the compression force upon securing to O-rings located far from the site where force is applied. By situating compression bolts near regions of the O-rings that are far from an edge of the slat, a better seal and no deformation of the plastic parts under fluid pressure is achieved. In this manner, although illustrated for two working fluids, hot water and vapor, more than two or more working fluids can be accommodated.

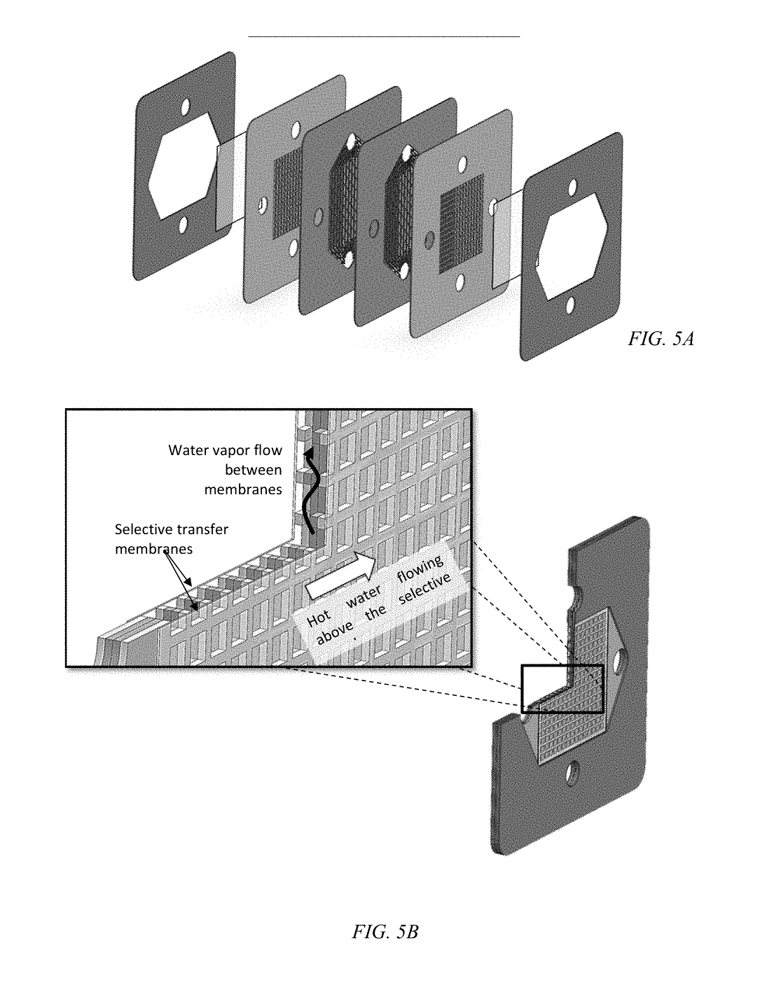

Plastic fabrication techniques that are cost effective and involve less sophisticated tooling than that required for injection molding, include, but not limited to, rotary and linear die cutting and sheet forming by vacuum or heat can be employed to form complex three dimensional geometries for vapor channels, according to an embodiment of the invention. In this manner, three dimensional geometries of the plastic parts that hold and support the selective membrane and create the flow channels can be fabricated from thin plastic sheets formed into discrete geometries. FIGS. 5A and B shows assemblies of plastic sheets patterned in this manner to form a membrane evaporator, according to an embodiment of the invention. In like manner, such methods can be employed to assemble a plastic sheet stack that acts as a condenser, dehumidifier, humidifier, or any other type of membrane-based heat and mass exchanger employing two or more fluids.

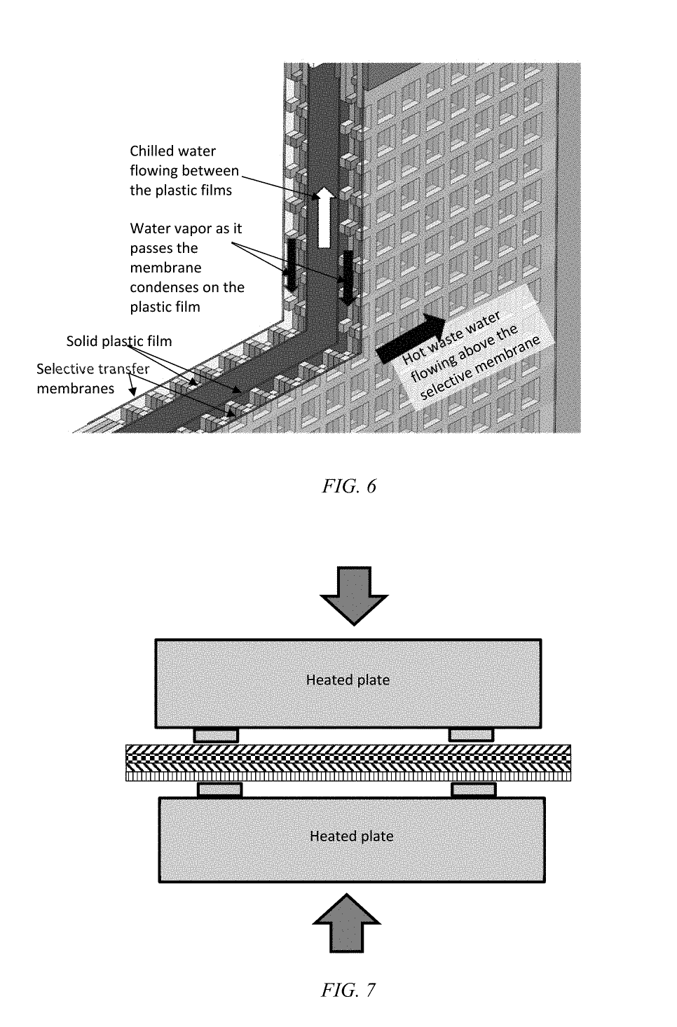

A waste water evaporator/condenser is illustrated in FIG. 6 that demonstrates configured and arranged sheets to process more than two fluids flowing through a heat and mass exchanger. As shown in FIG. 6, hot waste water flows over the selective membrane where water molecularly transfers across the selective membrane and is condensed over a plastic film that is being cooled by a chilled water stream. The sheets are welded together using heated plates to create sealed regions that unify the layers into a single laminate component, as shown in FIG. 7. Concentrating sufficient heat in regions where a seal is desired between multiple layers of plastic requires a reliable melting and welding of sheets to successfully form a plate. To overcome the thermal contact resistance between successive sheets of plastic that restricts heat to flow into the interior layers, various methods can be used to impart heat to the desired zones. These methods include, but not limited to: providing raised 3D areas on layers that make contact with the next layer or tooling to concentrate the conductive heat transfer; providing void spaces in some layers such that heat flux is conducted only along the path where welding is desired; pre-compressing or texturing areas of the plastic film to one or more faces of the desired bonding region before stacking such that the compressed areas has poor contact with the next layer and creating the equivalent of a void space to direct heat to the region with the best contact; and applying an intermediate substances with higher heat transfer coefficients than the plastic to enhance heat transfer in the desired regions.

An advantage of the laminate structures, according to an embodiment of the invention, is its ease of adaption to a web-to-web fabrication process. Each layer can start as a separate roll of stock where each individual roll is optimized in its material properties, thickness, or other features, before going through a high-speed stamping machine that cuts desired patterns into the material while leaving the pieces firmly attached to each other. This allows for pre-alignment of the different layers from the roles for a high-volume production of stacks as layers travel from the roles into position for compression and welding.

A fixed-plate energy recovery ventilator is a heat mass exchanger that does not incorporate internal plenums and manifolds. Instead, fluids enter and exit across the external faces of the device, which significantly reduces the cost by eliminating many elements of their design. These heat and mass exchangers employ plastic parts as spacers to create flow channels on both side of a membrane. These plastic parts are sheets that are thermoformed into a 3D shape, like a corrugation.

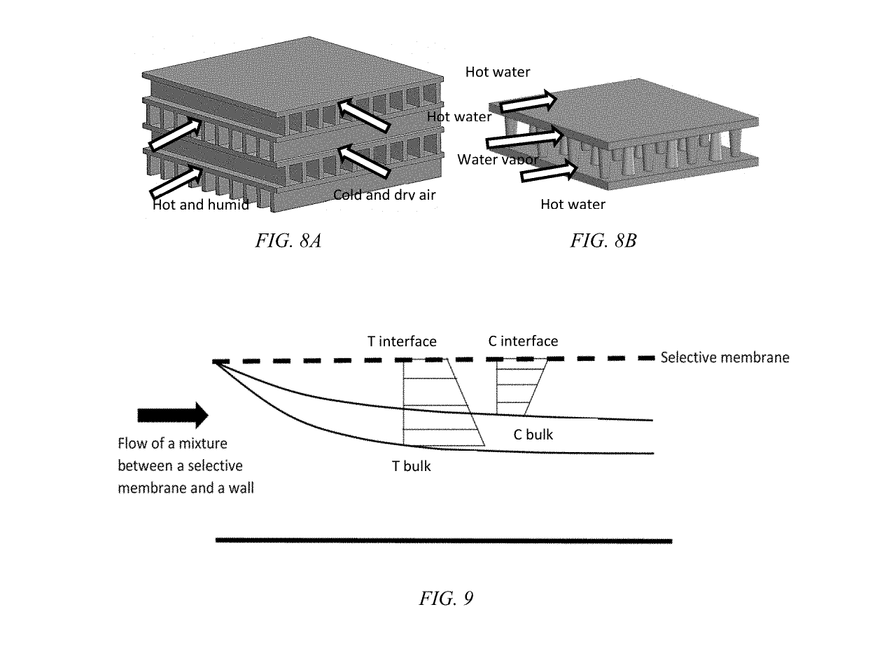

In an embodiment of the invention, a selective membrane is formed into a 3D geometry of flow channels without requiring additional spacer parts. The design of these 3D geometries and their assembly orientation depend on the application. As shown in FIGS. 8A and 8B, a membrane-based evaporator and a membrane-based air to air heat and mass exchanger, respectively, have selective membranes with an assembly orientation that allow different streams to exchange heat and mass without mixing. The addition of 3D features improves the heat and mass transfer by increasing the active heat and mass surface area while mixing the flow.

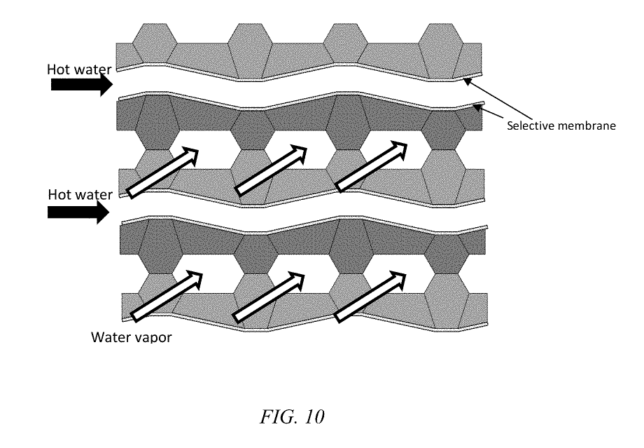

In a membrane-based heat and mass exchanger, when one or more of the fluids is a mixture, temperature and concentration polarization occurs near the membrane due to formation of temperature and concentration boundary layers. Therefore, the concentration and the temperature of the flow near the membrane (T_{interface} and C_{interface}) are different compared to the bulk of fluid flow, as illustrated in FIG. 9. This phenomenon has an adverse impact on the heat and mass transfer performance since it decreases the vapor pressure potential across the membrane. To enhance heat and mass transfer performance, these boundary layers can be disturbed by forcing mixing under flow. To achieve mixing, in an embodiment of the invention, features are provided to continuously change the direction of the flow. FIG. 10 shows substantially identical patterned plastic layers that form fluid channels between them as a serpentine channel. In the serpentine channels, the fluid has to change direction several times as it goes through the channel. The height and pitch of these serpentine channels induce vortices in the flow to achieve effective mixing.

The devices, according to embodiments of the invention, allow a stream of water or other liquid fluid on one side of the selective membrane and a stream of air or other suitable gaseous fluid on the opposite side of the selective membrane. The selective membrane acts to maintain a dynamic equilibrium between its surfaces, where, if the vapor pressure of the gas stream is lower than the vapor pressure of the liquid stream at any or all points along that surface, liquid molecules evaporate from the membrane surface into the gas stream or if the vapor pressure in the gas stream is greater than the liquid stream, transfer of water molecules to the liquid stream ensues. The heat of vaporization is either absorbed into or released from the molecules to effect that change, making both evaporative cooling and evaporative heating of the liquid possible. Using sealed structures to expose a membrane improves efficiencies over state of the art cooling tower designs by creating a known surface area of evaporation that is continually flushed on one side by the flow of liquid. This eliminates the uneven evaporation that creates local concentrations of contaminants and scale deposits. The membrane-based heat and mass exchangers, according to embodiment of the invention, enables evaporation and condensation using highly concentrated solutions.

In the membrane-based heat and mass exchangers, according to embodiment of the invention, careful sealing of the selective membrane to the underlying structure prevents leakage of the liquid solution under static or dynamic head pressure of a water column, which is important for practical considerations, and prevents escape of liquid droplets that can be carried off with the gas stream. By sealing the selective membrane, the elimination of the problem of transmission of microbial contamination assures greater safety of the devices.

Because the evaporative processes, according to embodiments of the invention, tolerate highly concentrated process water solutions various advantages are achieved. The advantages allow:

(1) Use of industrial wastewater produced on site to operate a cooling tower for the process to reduce the amount of water consumed and reduce the volume of wastewater that must be eliminated;

(2) Use of seawater, brine, or other concentrated water types to cool a power plant or process, at a location where potable water is precious and the compromised water cannot be used as the ultimate heat sink in the process, to dissipate heat to the air instead to the precious body of water, particularly in locations dealing with undesired temperature changes;

(3) Tapping a saline aquifer deep underground for water that is brought to the surface for a membrane cooling process at a power plant, which simultaneously reduces the pressure in the aquifer formation and makes it easier for the power plant to pump captured carbon dioxide into the rock formation for permanent storage and sequestration;

(4) thermal processing for wastewater treatment that must dissipate a certain amount of heat in to the environment as part of its process, where employing the wastewater as an evaporative cooling medium for this heat sink greatly increases the amount of water that is treated and removed from circulation, even if the water doesn't end up returning to the user.

The ability to create fluid streams sealed behind selective membranes allows the device, according to embodiments of the invention, to place four fluid streams into a single heat and mass exchanger. These can be characterized as:

Stream A being heated wastewater, which evaporates through a selective membrane to form;

Stream B being water vapor generated at the selective membrane and traveling a short distance within the slat to reach a nonporous heat transfer surface with no mass transfer capability, where the water vapor dissipates energy and condenses to pure liquid water;

Stream C being a cool wastewater stream that absorbs heat from the condensation of stream B and then evaporates through a selective membrane into;

Stream D, which is an air stream that carries the evaporated water vapor and its associated energy away from the device.

Evaporation of the wastewater can be used to reduce the volume of concentrated brine that must be disposed of to improve economics.

For evaporative based processors seeking to maximize evaporation of wastewater the sensible heat exiting the device into an air stream can be recaptured by using a heat exchanger to preheat the incoming air or the makeup water. This can minimize the energy lost to sensible heating that could otherwise be used for evaporation.

In an embodiment of the invention, membrane-based heat and mass exchangers are employed with brine for evaporative cooling without removing dissolved solids; these solids can be at total dissolved solids (TDS) levels that preclude other cooling tower technologies. Hence, brine pumped from the deep aquifer can be used for evaporative cooling in a cooling tower without practicing expensive desalination. In this manner, a power plant is evaporatively cooled using brine from a deep aquifer. A portion of the water from the concentrated brine evaporates to provide cooling with the remaining brine being concentrated to a desired level where the resulting brine solution is disposed of using conventional techniques, where the amount of water that must be removed is greatly reduced, making the process simpler and more economical easier than state of the art methods where the brine extracted from the well is treated before use. This method allows the power plant to use efficient cooling technology without the use of high-quality water sources that may be limited or not available at all in the vicinity of the power plant. Due to the reduction in the aquifer pressure by removal of the brine, large quantities of CO₂ produced at the power plant can be injected into the deep aquifer through a separate well in large quantities because of the lower pressures due to brine withdrawal. In this manner, due to the lower injection pressure ruptures of the caprock that contains the aquifer that allows migration of the CO₂ towards the surface can be avoided.

It should be understood that the examples and embodiments described herein are for illustrative purposes only and that various modifications or changes in light thereof will be suggested to persons skilled in the art and are to be included within the spirit and purview of this application.

We claim:

1. A membrane-based heat and mass exchanger, comprising:
a plurality of identically structured slats, each slat comprising at least one membrane support structure, a plurality of grooves, at least one first inlet port and one first outlet port for a first fluid, and at least one second inlet port and at least one second outlet port for a second fluid;
a plurality of O-rings or gaskets shaped to match the plurality of grooves, wherein the slats are aligned;
a plurality of selective membranes; and
a plurality of bolts or clamps for compressing the plurality of slats and the selective membranes into an assembly of slats, wherein a front face of the slats are contacted with the front face of the adjacent slat and a back face of slats are contacted with the back face of the adjacent slat such that the groves align the slats to restrict the first fluid to the front face and restrict the second fluid to the back face or restrict the second fluid to the front face and restrict the first fluid to the back face.

2. The membrane-based heat and mass exchanger, according to claim 1, wherein the slat comprises one of the at least one membrane support structure.

3. The membrane-based heat and mass exchanger, according to claim 1, wherein the slats are flat.

4. The membrane-based heat and mass exchanger, according to claim 1, wherein the slats comprise a plastic.

5. The membrane-based heat and mass exchanger, according to claim 1, wherein the selective membrane is Aqualyte™.

6. The membrane-based heat and mass exchanger, according to claim 1, wherein the slat comprises a multiplicity of the at least one membrane support structure wherein the multiplicity of the at least one membrane support structure is partitioned by the grooves into a plurality of combined membrane support structures.

7. The membrane-based heat and mass exchanger, according to claim 1, wherein the slat comprises a multiplicity of sheets.

8. The membrane-based heat and mass exchanger, according to claim 7, wherein the slat comprises a multiplicity of sheets comprise a plurality of selective membrane sheets and a multiplicity of plastic sheets.

9. The membrane-based heat and mass exchanger, according to claim 7, wherein the sheets comprise structures for forming serpentine channels by the pairing of two of the sheets with complementary features of height and pitch, wherein the features in an orientation define a plane defined by contacting the complementary features.

10. The membrane-based heat and mass exchanger, according to claim 1, wherein the membrane-based heat and mass exchanger functions as at least a portion of a chiller, evaporator, condenser, dehumidifier, or humidifier.

11. A method of preparing a membrane-based heat and mass exchanger according to claim 1, comprising
providing a plurality of slats, each slat comprising at least one membrane support structure, a plurality of grooves, at least one first inlet port and one first outlet port for a first fluid, at least one second inlet port and at least one second outlet port for a second fluid;
providing a plurality of selective membranes;
providing a plurality of O-rings or gaskets;
providing a plurality of bolts or clamps;
aligning the plurality of slats such that a front face of the slats are contacted with the front face of the adjacent slat and a back face of slats are contacted with the back face of the adjacent slat;
positioning the O-rings or gaskets between slats; and
compressing the plurality of slats into an assembly by securing the plurality of bolts or clamps.

12. The method of preparing a membrane-based heat and mass exchanger according to claim 11, wherein providing the slat comprises:
assembling a multiplicity of plastic sheets into an assembly, wherein the plastic sheets are patterned in complementary fashion, and wherein some of the sheets are patterned to support the selective membrane, some of the sheets are patterned to promote non-laminar fluid flow; and some sheets are patterned to secure the selective membranes and other sheets of the assembly.

13. The method of preparing a membrane-based heat and mass exchanger according to claim 12, wherein assembling further comprises compressing the assembly between heated plates to weld adjacent pairs of the sheets.

14. The method of preparing a membrane-based heat and mass exchanger according to claim 12, wherein the sheets comprise structures for forming serpentine channels by the pairing of two of the sheets with complementary features of height and pitch, wherein the features in an orientation define a plane defined by contacting the complementary features.

15. A cooling and carbon sequestering system, comprising at least one membrane-based heat and mass exchanger according to claim 1, a brine extraction well, and a CO₂ injection well, wherein a concentrated brine solution delivered to the at least one membrane-based heat and mass exchanger via the brine extraction well from an aquifer whereby a reduction of pressure occurs within the aquifer to accommodate the CO₂ pumped into the aquifer by the CO₂ injection well.

16. A method of providing cooling in a power plant and sequestering generated CO₂, comprising:
providing a cooling system comprising at least one membrane-based heat and mass exchanger according to claim 1,
removing a brine solution from an aquifer using a brine extraction well to for a reduced pressure aquifer;
flowing the brine solution as a coolant in the power plant to remove heat generated during power production to form heated brine solution;
flowing the heated brine solution as a first fluid into the at least one first inlet port of the at least one membrane-based heat and mass exchanger;
transporting water from the first fluid through the selective membranes of the membrane-based heat and mass exchanger into a second fluid on a side of the selective membrane distal to the first fluid, wherein the first fluid becomes a cooled concentrated brine solution,
removing the second fluid and water through the at least one second outlet of the at least one membrane-based heat and mass exchanger; and
injecting the generated CO₂ from the power plant using a CO₂ injection well into the reduced pressure aquifer.
